(19) United States
(12) Patent Application Publication
(10) Pub. No.: US 2006/0268911 A1
(43) Pub. Date: Nov. 30, 2006

(54) Method for routing ip-packets to an external control comonent of a network node in an ip-packet switching communications network comprising several network nodes

(76) Inventors: Johannes Bergmann, Bernried (DE); Anton Schmitt, Vaterstetten (DE); Dr. Christian Winkler, Munchen (DE)

Correspondence Address: SIEMENS CORPORATION;INTELLECTUAL PROPERTY DEPARTMENT, 170 WOOD AVENUE SOUTH, ISELIN, NJ, 08830, US

(21) Appl. No.: 10/558,901

(22) PCT Filed: May 27, 2004
(86) PCT No.: PCT/EP04/50950

§ 371 Date: Nov. 30, 2005

(30) Foreign Application Priority Data
May 30, 2003 (DE) 103 24 604.5

(51) Int. Cl. H04L 12/56

(52) U.S. Cl. 370/409

(57) ABSTRACT

According to one embodiment, IP-packets are received, identified, evaluated and processed at interfaces of a network node. An IP-tunnel is established from each interface of the network node to the control component. An in-band IP signaling packet, which is received at an interface of the network node and characterized by an entry in the protocol field of the header of the IP-packet, is routed through the IP-tunnel to the control component.

### CROSS REFERENCE To RELATED APPLICATIONS

This application is the US National Stage of International Application No. PCT/EP2004/050950, filed May 27, 2004 and claims the benefit thereof. The International Application claims the benefits of German application No. 10324604.5 DE filed May 30, 2003, both of the applications are incorporated by reference herein in their entirety.

### FIELD OF INVENTION

The invention relates to a method for routing IP packets to an external control component of a network node in an IP packets switching communications network.

### BACKGROUND OF INVENTION

Internet protocol networks (IP networks for short) will in future transport higher-quality services in addition to the current standard Internet and best-effort services, and will permit new applications. To this end enhancements to the control of the network nodes of an IP network or of the network controller are necessary, e.g. for administering the network resources or for fast reconfiguration in the event of errors.

In general the alternatives are to:
integrate control components into the network components, network nodes and/or network elements such as routers, or
link control components as external servers to the network components, network nodes or routers to be controlled. This can be done directly, i.e. by a connection or line between an external interface of the network component and the control component situated in the vicinity, or via a network connection between network component and control component.

The first integrated solution has the advantage that internal information in the network component is available to the control component thanks to the close link to the network component.

In contrast to this an “add-on” solution is vendor-independent and more flexible, precisely because it is not so closely interwoven with the internal aspects of the network component. In addition, “add-on” solutions can be based on standard hardware (HW for short) and software (SW for short) solutions, while network components such as routers are mostly based on proprietary HS/SW solutions. Shorter development cycles and cost savings can be achieved with “add-on” control components. The drawback of “add-on” solutions is that internal information in the network component is not available.

Using the example of an admission control (AC for short) component the problem of the second, external, “add-on” server solution is illustrated below.

One object of admission control is to accept incoming resource queries, compare them with resources still available and if resources are still available to program a network node or router, e.g. the router on the edge of the network (edge router) for control of the data flow. This includes setting what are known as functions, such as marking, filtering and policing.

The following two questions arise here, among others:
A) How do the resource queries reach the add-on control component or admission control?
B) How can the control component or admission control and configure the network node and from where does the control component obtain the necessary information about the internal aspects of the network component, e.g. at what interface was a packet received and what interface needs to be configured?

In principle, there are two variant solutions for A):
1) The data path which the IP packets take is known and accordingly the control component or admission control can be addressed directly. This is called “out-band signaling”.
2) The signaling protocol follows the path of the data packets and thus finds the control component or admission control automatically. This is called “in-band signaling”.

The following is based exclusively on signaling in accordance with variant 2), in other words in-band signaling.

The standardized resource reservation protocol RSVP is an in-band signaling protocol. It solves the questions outlined above as described under point 2) and performs a hop-by-hop reservation in the network node. The key point here is that the RSVP instance is implemented in the router itself and hence can operate with the router and its internal aspects on a very close-meshed basis.

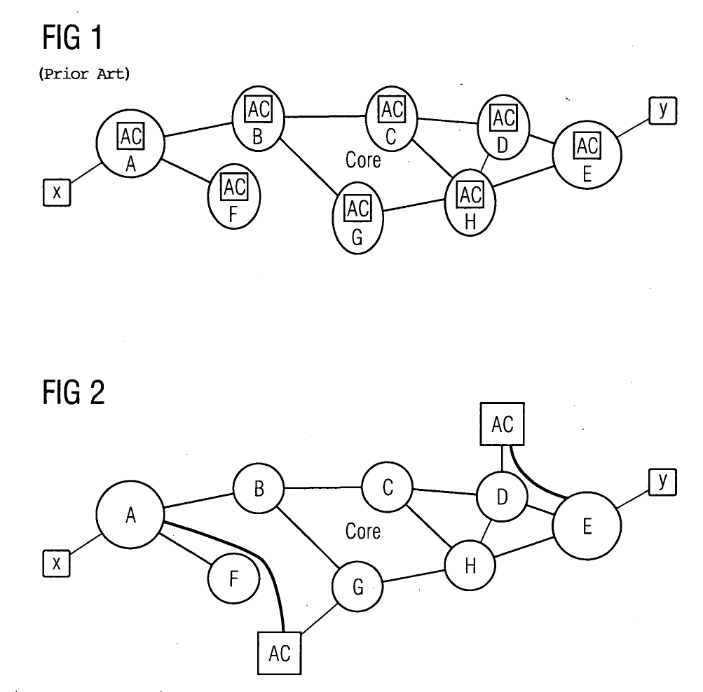

Using the example of an RSVP-capable network, i.e. of a network with RSVP-capable network nodes or routers in accordance with FIG. 1, the procedure will be described schematically.

FIG. 1 shows a schematic IP network, consisting of a plurality of network nodes or routers A to H, which in each case have a control component AC internally. The network node A is on the one hand connected by a series connection of the network nodes B, C, D and on the other hand by a series connection of the network nodes F, G, H to the network node E. The network nodes B and G, C and H as well as D and H are likewise connected to one another. The connections or connection paths are for example implemented as electrical or optical lines, such as two-wire lines, coaxial cable or optical fiber conductors. A user X is connected at network node A and a user Y is connected at network node E.

The user X generates a resource request to the network for a data flow to user Y. It must be ensured here that the resource reservations in the network nodes are also in fact undertaken along the subsequent data path. In IP networks this data path depends on the current routing. Hence in the resource reservation protocol RSVP the resource request is sent into the network with the IP destination address, in other words the IP address of the user Y. It thus automatically follows the data path of the subsequent data flow to user Y. Although these RSVP messages are now not addressed to the RSVP control components AC or RSVP instances, the RSVP control components AC or RSVP instances of the network nodes lying on the path must be notified of them.

Hence these messages are specially marked by the defined IP protocol type “RSVP” in the IP header, in other words in the header of an IP packet.

The routers identify this protocol type and route messages marked in this way directly to their RSVP instance, in other words to the control component AC.

Later, in the course of the procedure, the RSVP instance must configure “its” edge router A on the edge of the network to user X (filtering, marking, policing). In concrete terms, the interface to be configured is the one via which the RSVP message was originally received from user X and via which the data flow from user X to user Y will subsequently arrive. Since the RSVP instance is implemented in the router, it can interrogate this internal information.

The solution for the two points A and B lies here in the close internal link between network node and control component.
Re A) The resource queries reach the control component via special filters in the network node or router, which identify the protocol ID and forward the packets directly past the routing to the internal control component.
Re B) The control component AC receives information on the configuration of the network node or router by accessing router-internal data.

In the case of external control components the problem exists that this internal information is not interrogated in the case of the network node or made available by the network node. A further problem exists if the external control components of the network node are not provided thereto directly, but are located at a very remote place in the network and can only be reached via a network connection.

### SUMMARY OF INVENTION

An object of the present invention is to specify a method in which received IP packets can be routed with interface information in the receiving node to an external control component.

This object is achieved by methods in accordance with the features in the claims.

The advantage of the invention is that IP packets are routed with network-node-internal control information to an external control component. As a result a control component “added on” to a network node can assume comprehensive control tasks of the network node.

Another advantage is that the external control component can be disposed at a remote location in the network and is connected via a network connection.

Advantageous developments of the invention are specified in the d.

Brief Description Of The Drawings An embodiment of the invention is illustrated in the drawing and is explained in the following.

The drawings show:

FIG. 1 A schematic IP network with network-node-internal control components AC in accordance with the prior art.

FIG. 2 An IP network structured analogously to FIG. 1 with two external control components AC in accordance with the invention.

### DETAILED DESCRIPTION OF INVENTION

FIG. 1 shows an IP network in accordance with the prior art already explained in the introduction to the description.

FIG. 2 shows a network in accordance with FIG. 1, with the difference that in each case an external control component AC is connected at the network elements D and G.

Analogously to the example referred to in the introduction to the description, data packets are to be transferred from user X to user Y. The external control components AC here require particular IP packets, such as in-band IP signaling packets, for example RSVP packets, and the information about which interface of the network node the IP packet/in-band IP signaling packet/RSVP packet was received at. The latter information is only available internally in the network node and cannot be interrogated. The routing tables of the network node or router contain only information about destinations, but not about where a packet came from.

To solve the problem, rules are configured on the interfaces of the network nodes. Current network nodes or routers support what is known as policy routing, whereby rules can be configured for how to deal with special packets. Moreover, use is made of what is known as tunneling.

Using IP tunnels, e.g. GRE tunnels, the original IP packet is supplemented at the tunnel entrance by a tunnel header including a tunnel ID and a new external IP header. The IP packet is routed through the network with this IP header. At the end of the tunnel the external header is removed again and the original packet is further processed.

Modern network nodes or routers, in particular the edge routers involved here, often support one or more variants of tunneling.

The solution using tunnels is based on the fact that several tunnels can be set up from the network node or router (start of the tunnel) to the control component AC or control instance (end point) and can be distinguished by their tunnel identification number (tunnel ID for short) in the tunnel header.

A first variant consists in using the tunnel ID to transfer internal information. Thus for each interface of the network node a separate tunnel is set up to the control component, so that the interface number corresponds explicitly or implicitly to the tunnel ID.

To this end a tunnel is set up from each interface of the network node to the control component. To do this, a rule is set up in the network node or on the interface, that particular IP packets, such as in-band IP signaling packets which are marked by an entry in the protocol field of the IP header of the IP packet, are packed in a second, “external” IP packet, the IP address of the control component assigned to the network node is entered as the destination IP address in the “external” IP packet and a value unambiguously assigned to the interface which differs from the values of the other interfaces of the network node and with which the interface can be unambiguously identified, is entered as a tunnel ID in the “external” IP packet. This packet is forwarded by the IP routing to the control component. In similar fashion, in-band IP signaling packets of the type “RSVP” are packed and transmitted.

The advantage of this tunnel solution is that the control components or control instances need not be connected directly to the network node or router, but can be positioned anywhere in the network, as illustrated in FIG. 2 by way of example by the control components AC at the network nodes D and G. The control components AC can then be reached via the logical “direct interface” tunnel.

In a parallel patent application by the applicant a solution for a similar object is proposed using what is known as DSCP marking. In the case of a particular received IP packet, such as an in-band IP signaling packet of the type “RSVP”, the value of a particular field, such as the DSCP field, the IP header or header field of the IP packet, is here changed and a value dependent on the receiving interface of the network node is entered into the particular header field/DSCP field. This solution can be combined with the tunnel solution. Thus tunnels can be set up and in addition the DSCP fields of an IP packet can be modified.

The rules on the interfaces of the network nodes then contain a corresponding marking, such as DSCP marking, and the corresponding tunnel as the “next-hop” entry.

In the following the DSCP field is assumed to be the field to be changed, but another field in the header of the IP packet can also be used.

If DSCP marking and tunneling is used, a DSCP field change or a DSCP marking should be undertaken on the internal IP header. The external IP header can then actually be used for DSCP priority marking.

Moreover the tunnel ID need no longer contain a value assigned to the interface, since this value is unambiguously entered into the DSCP field.

In addition there is no need for a tunnel to the assigned control component to be set up from every interface. Thus at least one tunnel to the control component could be set up from the network node, whereby all IP packets of a particular type, such as in-band IP signaling packets, e.g. “RSVP” packets, are transmitted to the control component and the distinction as to which interface the packet was received at is made by the changed DSCP field.

Since the DSCP field is 6 bits in size, permitting a range of 64 values, the available value range is increased by a combination of tunneling and DSCP marking. As a result a large range can be covered with few tunnels. Using e.g. 2 tunnels and DSCP marking it is thus possible to distinguish 128 values or interfaces of the network node.

Tunneling can also be achieved by multiprotocol label switching, MPLS for short. The method is analogous to IP tunnels, with the difference that MPLS “tunnels” or MPLS paths are used instead of the IP tunnels.

With multiprotocol label switching, MPLS for short, states are maintained network-wide which define the routes or paths on which packets are routed through the network circumventing the “normal” IP routing. The network nodes here no longer route packets on the basis of the destination IP addresses, but a bit sequence, known as a label, is attached to each packet on entrance to the network. This label, which is evaluated in every network node, determines the route on which the packets are forwarded. The correlation between labels and paths must be created when the network is commissioned. The label is removed again at the network exit. In addition local mechanisms or rules are required to divert packets onto a backup path if the path originally envisaged crashes, or to establish a backup path after a crash.

An in-band IP signaling packet or an IP packet of the type “RSVP”, or of another type, received at an interface of the network node is identified here and an MPLS label is prefixed to the packet, the label ID of which is unambiguously assigned to the receiving interface and leads to the control component assigned to the network node. The IP packet packed in this way is routed to the control component by means of MPLS. The MPLS label ID prefixed to the IP packet is evaluated in the control component and the interface on which the IP packet was received from the network node is determined in the control component.

On the interface of the network node the rule is implemented that a particular value, permanently defined for the interface, is prefixed to the IP packet as an MPLS label and the packet is routed using MPLS. Using the MPLS method it must be ensured that packets with a particular MPLS label ID lead to the corresponding destinations, in this example to the control component.

In this case too MPLS can be combined with DSCP marking, in similar fashion to the method described above. Here it is sufficient if at least one MPLS label ID is entered in the network node, since the interfaces of the network node are distinguished by the DSCP marking.

For example, an in-band IP signaling packet or a packet of the type “RSVP” received at an interface of the network node is identified and is processed such that the value of a particular field, such as of the “DSCP” field, is changed as a function of the receiving interface. For example, an unambiguous interface ID, which differs from the interface ID of the other interfaces of the network node, is entered into the DSCP field, an MPLS label is further prefixed to the IP packet and this changed packet is routed by the MPLS method to the control component. It is not necessary here for every interface to enter a separate MPLS label ID, since the interfaces are distinguished by the DSCP field. Likewise large value ranges can be achieved by combining MPLS label ID and DSCP marking. Using e.g. 2 MPLS label IDs and DSCP marking it is possible to distinguish 128 values or interfaces of a network node.

1-9. (canceled)

10. A method for routing Internet Protocol (IP) packets to a control component external from a network node in an IP packet switching communications network, comprising:
providing a network node having a plurality of interfaces;
setting up an IP tunnel to an external control component from each interface of the network node;
receiving an in-band IP signaling packet at one of the plurality of interfaces, the packet marked by an entry in a protocol field of a header in the packet; and
routing the packet through the IP tunnel to the external control component.

11. The method according to claim 10, wherein the received packet is an “RSVP” type packet.

12. The method according to claim 12, wherein the external control component is directly connected to the network node.

13. A method for routing Internet Protocol (IP) packets to a control component external from a network node in an IP packet switching communications network, comprising:
providing a network node having a plurality of interfaces;
assigning a unique value to each interface;
setting up at least one IP tunnel to an external control component from the network node;
receiving an in-band IP signaling packet at one of the plurality of interfaces, the packet marked by an entry in a protocol field of a header in the packet;
changing a field in the header of the packet to include the value associated with the receiving interface; and
routing the changed packet through the IP tunnel to the external control component.

14. The method according to claim 13, wherein prior to routing the changed packet, the method further comprising,
identifying the received packet as an “RSVP” type packet, and
changing a “DSCP” field in the header as a function of the receiving interface.

15. The method according to claim 14, wherein the routing is based on an MPLS method and prior to routing the changed packet, the method further comprising,
identifying the received packet as an “RSVP” type packet, and
prefixing to the packet an MPLS label dependent on the receiving interface.

16. The method according to claim 16, wherein the external control component is directly connected to the network node.

17. A method for routing Internet Protocol (IP) packets to a control component external from a network node in an IP packet switching, MPLS-capable communications network, comprising:
providing a network node having a plurality of interfaces;
receiving an in-band IP signaling packet at one of the plurality of interfaces, the packet marked by an entry in a protocol field of a header in the packet;
prefixing a MPLS label to the packet; and
routing the changed packet through to the external control component via an MPLS method.

18. The method according to claim 17, wherein prior to routing the changed packet
entering into a field in the header of the packet a value associated with the receiving interface, the value different than another value on the non-receiving interface.

19. The method according to claim 18, prior to routing the changed packet, the method further comprising,
identifying the received packet as an “RSVP” type packet, and
changing a “DSCP” field in the header as a function of the receiving interface.
